(19) United States
(12) Patent Application Publication
(10) Pub. No.: US 2023/0234171 A1
(43) Pub. Date: Jul. 27, 2023

(54) METHOD FOR WELDING USING A WIRE-TYPE FILLER MATERIAL AND AT LEAST ONE LASER BEAM

(71) Applicant: KJELLBERG-STIFTUNG, Finsterwalde (DE)

(72) Inventors: Michael SCHNICK, Klipphausen (DE); Nils BROCKE, Schkopau OT Korbetha (DE); Frank SILZE, Klipphausen (DE)

(21) Appl. No.: 18/001,892

(22) PCT Filed: Jun. 15, 2021
(86) PCT No.: PCT/EP2021/066078

§ 371 Date: Dec. 15, 2022

(30) Foreign Application Priority Data
Jun. 18, 2020 (DE) 10 2020 207 573.5

(51) Int. Cl. B23K 26/70; B23K 26/21

(52) U.S. Cl. CPC B23K 26/702; B23K 26/21

(57) ABSTRACT

In a method for welding using a wire-shaped filler and at least one laser beam, the wire-shaped filler is advanced in the direction of the surface of the workpiece by a wire feed mechanism. The wire-shaped filler is successively fused during the feed movement thereof. The wire-shaped filler and the material are connected to an electrical voltage source and form an electrical circuit. The electrical voltage, the electrical current and/or the electrical resistance are measured and used as control variables for the wire feed movement and/or the power of the at least one laser beam. Use of the laser beam is modified when a predefined threshold value of the electrical voltage and/or of the electrical current are fallen short of or a predefined threshold value of the electrical resistance is exceeded.

The invention relates to a method for welding using a wire-shaped filler and at least one laser beam.

The formation of integral bonds of workpieces or build-up welding, which can also be used in additive manufacturing, are known in principle to employ laser radiation and wire-shaped filler.

The term ‘wire-shaped’ shall also be understood to encompass ribbons of a filler material, which do not entirely have a convex surface of the outer lateral area thereof. It is also possible to use cored fillers.

The welding of components and the additive manufacturing process building thereon using what are known as directed energy deposition methods have been the state of the art for many years. In recent years, laser-based applications have been increasingly added, in which the wire material can be fed either laterally or coaxially.

A fundamental problem with wire-based welding method is that the wire position must be exactly accurate, especially in the case of laser-based processes, since otherwise burnback (too little wire) or bird-nesting (too much wire) of the wire occurs. The problem essentially exists at the start of the process. The wire initially has to be positioned on the component or a certain surface. During the process, irregularities, for example a variation in the process spacing, can cause bird-nesting of the wire. This can prompt the wire to buckle and, consequently, disrupt the process (so-called wire jam).

It is therefore the object of the invention to monitor a positioning of the wireshaped filler at the start of the process, as soon as the wire rests on the surface of the particular material or component and makes contact therewith. Additionally, it is to be ensured in the process that the wire-shaped filler is permanently in contact with the workpiece or a component, so that the wireshaped filler tearing and burnback thereon can be avoided, and a smooth process, in which the wire-shaped filler is sufficiently in contact with the particular surface, can be achieved.

This object is achieved according to the invention by a method having the features of claim 1. Advantageous embodiments and refinements of the invention can be implemented with features described in the dependent claims.

In the method, wire-shaped filler and at least one laser beam are directed at a surface of at least one workpiece to be processed in the manner known per se. Wire-shaped filler is advanced in the direction of the surface of the workpiece by means of an accordingly designed wire feed mechanism and is successively fused during the feed movement in the area of the wire-shaped filler that is arranged directly above the particular surface, using the energy of the at least one laser beam.

The wire-shaped filler and the material are connected to an electrical voltage source and form an electrical circuit.

The electrical voltage, the electrical current and/or the electrical resistance in the electrical circuit are measured and used as control variable or variables for the wire feed movement and/or the power of the at least one laser beam, wherein the power with which the at least one laser beam is operated is reduced, or the at least one laser beam is switched off or not switched on, when a predefined threshold value of the electrical voltage and/or of the electrical current are fallen short of or a predefined threshold value of the electrical resistance is exceeded. Moreover, the signals can be used to initiate the start, the stop or the abortion of the process.

If multiple laser beams are used, which are directed together at the wireshaped filler, a reduction in the power can also be achieved by switching off at least one of these laser beams.

The at least one laser beam can advantageously be switched off or not be switched on when no electrical current flows in the electrical circuit. As an alternative, this can also take place when the electrical resistance has reached a value in the range of 10Ω to 1000Ω.

There is also the option of determining the first derivative of at least one of the control variables in an electronic evaluation unit and, when the absolute value of the first derivative of the particular control variable exceeds a predefined threshold value, the power with which the at least one laser beam is operated is reduced or the at least one laser beam is switched off.

However, it is also possible to determine the first derivative of at least one of the control variables in an electronic evaluation unit and, when the absolute value of the first derivative of the particular control variable exceeds a predefined threshold value, the wire feed can be controlled.

By determining the increase, the option exists to respond sooner. For example, there is no need to wait until in fact no electrically conducting contact exists between the wire-shaped filler and the material. In this way, it is possible to respond sooner when, for example, the electrical current drops drastically or the electrical resistance increases drastically. It is possible in this way to respond already when the absolute value of the respective first derivative becomes greater than 0.5.

The electrical voltage source can be operated with an electrical voltage of greater than 0 V, for example with approximately 5 V. The electrical voltage, however, should be no more than 48 V.

After the power with which the at least one laser beam is being operated has been reduced, or after the at least one laser beam has been switched off when carrying out a feed movement of the wire-shaped filler, it is possible either to increase the power of the at least one laser beam back to the normal operating power, or to switch the at least one laser beam back on, so that the process can be continued again when an appropriate positioning of the tip of the wire-shaped filler pointing in the direction of the workpiece surface in relation to the workpiece surface has been reached, at which an electrically conducting connection has been reached and electrical current flows through the electrical circuit. In the process, if necessary, a waiting period may be adhered to before the electrical power is increased again or the at least one laser beam is switched back on.

When a threshold value of the particular control variable(s) is fallen short or exceeded, the power with which the at least one laser beam is operated should be reduced such that no fusion of filler occurs. In this way, defects and flaws as well as burnback at the wire-shaped filler can be avoided.

In the process, the power with which the at least one laser beam is operated or the at least one laser beam should be reduced or switched off within no more than 100 ms.

After the power with which the at least one laser beam is being operated has been reduced, or after the at least one laser beam has been shut off, and a value of the particular control variable(s) which is above or below the particular threshold value has been reached, the power of the at least one laser beam can be increased up to the normal operating power thereof, or the at least one laser beam can be switched back on. This can take place, for example, when an accordingly large electrical current flows in the electrical circuit, a corresponding electrical volage is present there, or the electrical resistance has dropped to a sufficiently small value.

In this way, the welding process can be automatically started back up when suitable conditions are present in the meantime and, in particular, wireshaped filler has been positioned in relation to the workpiece surface in an appropriate manner.

The invention will be described by way of example hereafter.

In the drawings:

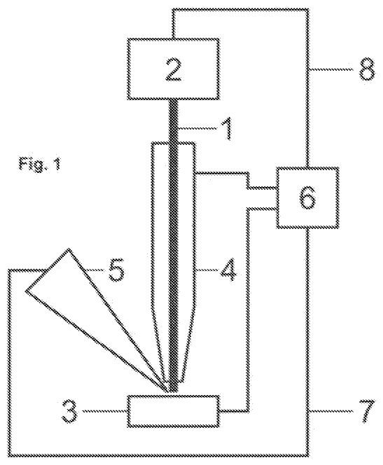

FIG. 1 schematically shows an example of a device, which is suitable for carrying out the method according to the invention.

Wire-shaped filler 1 is moved by a wire feed mechanism 2 in the direction of a surface of a workpiece 3 through a wire guide 4. The wire guide is connected to a terminal of an electrical voltage source (not shown). The second terminal of the electrical voltage source is electrically conductively connected to the workpiece 3.

Moreover, a laser beam 5 is directed at the tip of the wire-shaped filler 1, which points in the direction of the workpiece surface, and material of the wire-shaped filler 1 is successively fused there, which is used for welding.

An electronic evaluation unit 6 is present between the connecting contacts of the electrical voltage source of the wire guide and the workpiece 3, which is designed to determine the electrical voltage, the electrical current and/or the electrical resistance in the electrical circuit and to use this as a controlled variable for the wire feed movement and/or for the power of the at least one laser beam 5, as is described in the general part of the description. For this purpose, the electronic evaluation and control unit 6 is connected via the lines 7 and 8 to the wire feed mechanism 2 or the laser radiation source or a controller of the laser radiation source (neither is shown) for influencing the wire feed movement or the power of the laser beam 5.

1-9. (canceled)

10. A method for welding using a wire-shaped filler and at least one laser beam, which are directed at a surface of at least one workpiece to be processed, comprising:
a wire-shaped filler being advanced in the direction of the surface of the workpiece by an accordingly designed wire feed mechanism, and wire-shaped filler being successively fused during the feed movement thereof in the area that is arranged directly above the particular surface, using the energy of the at least one laser beam, the wire-shaped filler and the material being connected to an electrical voltage source and forming an electrical circuit, the electrical voltage, the electrical current and/or the electrical resistance in the electrical circuit being measured and used as controlled variables for the wire feed movement and/or the power of the at least one laser beam, and the power with which the at least one laser beam is operated being reduced, or the at least one laser beam being switched off or not switched on, or the start, the stop or the abortion of the welding process being initiated, when a predefined threshold value of the electrical voltage and/or of the electrical current are fallen short of or a predefined threshold value of the electrical resistance is exceeded.

11. The method according to claim 10, wherein the at least one laser beam is switched off or not switched on when no electrical current flows in the electrical circuit or the electrical resistance has reached a value in the range of 10Ω to 1000Ω.

12. The method according to claim 10, wherein the first derivative of at least one of the control variables is determined in an electronic evaluation unit and, when the absolute value of the first derivative of the particular control variable exceeds a predefined threshold value, the power with which the at least one laser beam is operated is reduced or the at least one laser beam is switched off.

13. The method according to claim 10, wherein a first derivative of at least one of the control variables is determined in an electronic evaluation unit and, when the absolute value of the first derivative of the particular control variable exceeds a predefined threshold value, the wire feed is controlled.

14. The method according to claim 10, wherein the electrical voltage source is operated with a maximum electrical voltage of 48 V.

15. The method according to claim 10, wherein after the power with which the at least one laser beam is being operated has been reduced, or after the at least one laser beam has been switched off when carrying out a feed movement of the wire-shaped filler, either the power of the at least one laser beam is increased back to the normal operating power or the at least one laser beam is switched back on.

16. The method according to claim 10, wherein when a threshold value of the particular control variable(s) is fallen short or exceeded, the power with which the at least one laser beam is operated is reduced such that no fusion of wire-shaped filler occurs.

17. The method according to claim 10, wherein the power with which the at least one laser beam is operated or the at least one laser beam is reduced or switched off within no more than 100 ms.

18. The method according to claim 10, wherein after the power with which the at least one laser beam is being operated has been reduced, or after the at least one laser beam has been shut off, and a value of the particular control variable(s) which is above or below the particular threshold value has been reached, the power of the at least one laser beam is increased up to the normal operating power thereof, or the at least one laser beam is switched back on.
